(19) United States
(12) Patent Application Publication
(10) Pub. No.: US 2025/0249616 A1
(43) Pub. Date: Aug. 7, 2025

(54) Cutting head assembly and knives for cutting food products into strips, and assembly method

(71) Applicant: Stumabo International N.V., Aartselaar (BE)

(72) Inventor: Brent Bucks, Lakewood Ranch, FL (US)

(73) Assignee: Stumabo International N.V., Aartselaar (BE)

(21) Appl. No.: 18/857,480

(22) PCT Filed: Apr. 27, 2023
(86) PCT No.: PCT/EP2023/061154

§ 371 Date: Oct. 17, 2024

Related U.S. Application Data
(60) Provisional application No. 63/336,313, filed on Apr. 29, 2022.

(51) Int. Cl. B26D 7/06; B26D 1/00; B26D 1/03; B26D 3/18; B26D 7/26

(52) U.S. Cl. CPC B26D 7/0658; B26D 1/0006; B26D 1/03; B26D 7/2614; B26D 2001/0033; B26D 2001/0053; B26D 3/185; B26D 2210/02

(57) ABSTRACT

Cutting head assembly for cutting food products into strips, comprising: a plurality of knives provided to be stacked on top of each other to form a knife stack for cutting food products, which are driven through a central opening of the cutting head assembly from an entry side towards an exit side, into strips, and a body for holding the knife stack. The body comprises first and second body segments which mate with each other and are together provided for forming slots for holding end portions of the knives and for defining the central opening of the cutting head assembly. The cutting head assembly has fewer parts and/or may be assembled and disassembled more quickly.

### FIELD OF THE DISCLOSURE

The present disclosure relates to a cutting head assembly, or cutter blade assembly, for cutting food products into strips, for example for use in hydraulic cutting apparatuses and/or for cutting tuberous vegetables like potatoes. The disclosure further relates to knives for such a cutting head assembly and to an assembly method.

### BACKGROUND ART

Hydraulic cutting apparatuses are known, which can be used to cut relatively large quantities of food product at very high speeds, such as for example potatoes into strips.

In a typical hydraulic cutting apparatus wherein potatoes are to be cut, the potatoes are pumped through a conduit into an alignment chute wherein the potatoes are aligned and accelerated to high speeds before impinging upon a cutter blade assembly where the potato is cut into a plurality of smaller pieces. Obviously, there are a variety of other applications for hydraulic cutter knives other than just for potatoes. A typical cutter blade assembly comprises a plurality of knives stacked on top of each other to form a pyramidal knife stack for cutting the food products.

U.S. Pat. No. 6,725,765 B1 discloses a cutter blade assembly for cutting vegetable products such as potatoes. The cutter blade assembly utilizes a number of cutter blades that transverse an axial bore through which products to be cut are fed. These blades are locked within the assembly by an attachment system that partially deforms the blade to hold the blade in place.

U.S. Pat. No. 6,321,628 B1 discloses knives for such a pyramidal knife stack. The knives comprise a flank portion and a longitudinal edge having an oblique cutting edge, the knife positionable with respect to the knives in sleeves provided perpendicularly to the cutting edge of the blade, at least one sleeve having an oblique cut bottom side.

A disadvantage of known cutter assemblies is that assembling and disassembling the assembly may be time consuming due to the number of parts and/or a construction wherein each individual knife needs to be fixed to a holder by means of screws.

NL192376 C discloses a chip cutter system which comprises a cutter block. The cutter block consists of two cylindrical housing sections which together form a cylindrical passage. The first housing section has four recesses and the second housing section has four protruding ribs which are complementary to the recesses. The protruding ribs are bolted to the carrier support plate. The cutter block known from this document has fewer parts and thus may reduce the assembly time. However, the accuracy of the positions of the knives held between the housing sections has been found to be insufficient.

### SUMMARY OF THE DISCLOSURE

It is an aim of the present disclosure to provide an improved cutting head assembly of the type comprising a knife stack, for example for use in hydraulic cutting apparatuses.

In particular, it is an aim of the present disclosure to provide a cutting head assembly of the type comprising a knife stack, for example for use in hydraulic cutting apparatuses, which can be assembled and disassembled more quickly and/or which has fewer parts and/or wherein more accurate knife positioning may be achieved.

It is another aim of the present disclosure to provide improved knives for such cutting head assemblies.

In a first aspect, which may be combined with other aspects and/or embodiments described herein, the present disclosure relates to a cutting head assembly, or cutter blade assembly, for cutting food products into strips, for example for use in hydraulic cutting apparatuses and/or for cutting tuberous vegetables like potatoes, the cutting head assembly comprising: a plurality of knives provided to be stacked on top of each other to form a knife stack for cutting food products, which are driven through a central opening of the cutting head assembly from an entry side towards an exit side, into strips, and a body for holding the knife stack. The body preferably comprises a number of first body segments and a number of second body segments. The first and second body segments mate with each other and are together provided for forming slots for holding end portions of the knives and for defining the central opening of the cutting head assembly. In this way, the knives are held between the opposing surfaces of the body segments and the need for individually securing the knives by means of screws can be avoided. Furthermore, the body segments also mate into each other to form the central opening of the cutting head assembly, which is preferably cylindrical, so there is no need for additional parts to form or define the central opening. As a result, a cutting head assembly may be achieved which has fewer parts and/or which may be assembled and disassembled more quickly.

The first body segments together form a first part of the body of the cutting head assembly. The second body segments together form a second part of the body of the cutting head assembly, which mates with the first part. By this construction with a plurality of first body segments and second body segments, it has been found that, surprisingly, the surfaces for supporting and/or positioning the knives between the first and second parts can be defined more accurately, which may in turn lead to improvements in the positioning of the knives in the knife stack. In other words, it has been found that in this construction the manufacturing tolerances for these surfaces may be reduced, leading to an improved fit of the assembled first and second body segments on each other. In embodiments according to the present disclosure, the first part of the housing may be composed of two, three, four, five, six, seven, eight or more first body segments and the second part of the housing may be composed of two, three, four, five, six, seven, eight or more second body segments. The preferred number of first and second body segments may depend on factors such as the material in which the segments are made, the manufacturing process, the configuration of the knife stack, or other. For example, for a pyramidal knife stack comprising knives that cross each other at right angles, examples of which are disclosed herein, a preferred embodiment of the body of the cutting head assembly may have two pairs of identical first body segments and two pairs of identical second body segments.

In embodiments according to the present disclosure, each first body segment may have a stepwise tapered shape which tapers upwards, towards the exit side, and comprises a plurality of first knife mounting surfaces, wherein each second body segment has a stepwise tapered shape which tapers downwards, towards the entry side, and comprises a plurality of second knife mounting surfaces, arranged to oppose the first knife mounting surfaces, and wherein in assembled state the end portions of the knives are held in the slots formed between the opposing first and second knife mounting surfaces of the first and second body segments. The mating tapered shapes of the first and body segments may provide for a body which has only a few parts and which facilitates stacking the knives onto each other upon assembling the knife stack.

In embodiments according to the present disclosure, the cutting head assembly may further comprise a clamping system, or clamping mechanism, for clamping the first and second body segments onto each other. In embodiments, the clamping system may comprise: a bottom part, provided for contacting bottom sides of the first body segments, a top part, provided for contacting top sides of the second body segments, and a plurality of clamping bolts for drawing the top part towards the bottom part with the first and second body segments clamped in between the top part and the bottom part. Such a clamping system or mechanism may provide for a quick and/or easy way to secure the first and second body segments onto each other with the knives of the knife stack held in between them, in accurate positions.

In embodiments according to the present disclosure, in assembled state, the clamping bolts preferably extend through bores which are provided in height direction of the cutting head assembly through at least some of the body segments. Preferably, the bores are provided in the second body segments.

In embodiments according to the present disclosure, each second body segment may comprise a plurality of clamping surfaces arranged for pushing onto top sides of the end portions of the knives. In this way, it can be ensured that in assembled state all the knives are pushed down onto each other and are accurately located in the desired position in the knife stack.

In embodiments according to the present disclosure, in assembled state, bottom surfaces of the second body segments are spaced from the bottom part. In this way, it can be ensured that upon assembling the cutting head the clamping surfaces of the second body segments push the knives down and are not obstructed by the bottom surfaces touching the bottom part.

In embodiments according to the present disclosure, the top and bottom parts may comprise positioning ridges which in assembled state surround or mate with portions of the first and second body segments to ensure a correct positioning of the body segments with respect to each other.

In embodiments according to the present disclosure, the bottom part may be a bottom plate to which the first body segments are bolted upon assembling the cutting head. This may provide a simple construction, which can be placed in upright position for easily mounting and stacking the knives onto the first body segments.

In embodiments according to the present disclosure, the top part may be a head block with a tapered central opening which in assembled state aligns with the central opening formed by the body segments and which tapers towards the exit side of the cutting head assembly. This tapered hole may provide for a more laminar flow of the liquid of a hydraulic cutting system through the cutting head.

The cutting head assembly according to any one of the preceding claims, wherein the first body segments are provided with positioning aids to aid in correctly positioning the knives upon assembling the knife stack. The knives may be provided with complementary shapes or features which cooperate with the positioning aids. This may further facilitate the process of assembling the knives to form the knife stack.

In embodiments according to the present disclosure, the cutting head assembly may be provided for being mounted in a hydraulic cutting system.

In a second aspect, which may be combined with other aspects and/or embodiments described herein, the present disclosure relates to knives for forming a knife stack of a cutting head assembly, for example a cutting head assembly as described herein, but not exclusively. The second aspect provides a set of knives for forming a knife stack, wherein each knife comprises a longitudinal cutting edge, a lower portion which extends upwards from the cutting edge and an upper portion which extends upwards from the lower portion.

In embodiments, the upper portion may have a reduced thickness with respect to the lower portion. This implies that the knives comprise a step at the transition from the lower portion to the upper portion, which extends in longitudinal direction of the knife and preferably over the entire length of the knife. More in particular, the lower portion may have a bevelled portion at the cutting edge, where the thickness gradually increases starting from the cutting edge up to a middle portion of the knife, which is the thickest portion of the knife and located just below the step, and the upper portion preferably has a reduced thickness with respect to this thickest middle portion of the knife. Except for the bevelled portion, the lower portion may generally have substantially the same thickness, i.e. at the middle portion and at end portions of the knife on opposite sides of the bevelled portion. The reduced thickness of the upper portion with respect to the lower portion may achieve that cut off portions of product which is fed through the knife stack is less compressed between the knives.

In embodiments, at least one of the upper portion and the lower portion of each knife may comprise slots for receiving the knives of the preceding and/or subsequent level of the knife stack. Preferably, the slots in the lower portion are wider than the thickness of the upper portion and narrower than the thickness of the lower portion, such that there is at each level a portion of the cutting edge of the respective knife behind the step of the knife on the preceding level. In this way, it can be ensured that the product is completely cut at each level, consequently avoiding that fibers of the cut product get stuck or build up in the slots in the lower portions of the knives.

In embodiments, the slots in the upper portions of the knives may be tapered, such that these slots substantially conform to the cross-section of the lower portion of the knives (which tapers due to the bevelled portion). Preferably, the bottom end of the slots in the upper portions are contoured or rounded to avoid cracking of the knives.

In embodiments, the knives may be provided with positioning elements complementary to positioning aids provided on the first body segments of the cutting head assembly. In particular, the positioning elements on the knives may correspond in position, shape and/or size with the positioning aids on the first body segments of the cutting heads according to the present disclosure.

In a further aspect, which may be combined with other aspects and/or embodiments described herein, the present disclosure relates to a method for assembling a cutting head assembly comprising a knife stack and a body for holding the knife stack, wherein the body comprises first and second body segments which mate with each other and are together provided for forming slots for holding end portions of the knives and for defining a central opening of the cutting head assembly, the method comprising the steps of: (i) mounting the first body segments of the body, (ii) mounting the knives on the first body segments to form the knife stack, and (iii) mounting the second body segments on the first body segments, whereby the end portions of the knives are held in the slots formed between the first and second body segments and whereby the central opening is formed.

In embodiments according to the present disclosure, the method may comprise bolting the first body segments to a bottom part of the cutting head assembly and clamping the second body segments onto the first body segments by means of a clamping system.

In embodiments according to the present disclosure, the second body segments, upon being clamped onto the first body segments, push the knives down onto knife supporting surfaces on the first body segments.

### BRIEF DESCRIPTION OF THE DRAWINGS

Embodiments of the present disclosure will be discussed in more detail below, with reference to the attached drawings.

FIG. 1 shows a perspective view of a first embodiment of a cutting head assembly according to the present disclosure.

FIGS. 2 and 3 respectively show a top view and a bottom view of the cutting head assembly of FIG. 1.

FIGS. 4-13 show perspective views of parts of the cutting head assembly of FIG. 1 and its assembly method.

FIGS. 14-16 show details of the cutting head assembly of FIG. 1.

FIG. 17 shows a perspective view of a second embodiment of a cutting head assembly according to the present disclosure, with some parts removed.

FIGS. 18-23 show views of an embodiment of knives for forming a knife stack according to the present disclosure.

FIGS. 24 and 25 show detailed views of further embodiments of knives for forming a knife stack according to the present disclosure.

FIGS. 26 and 27 show perspective views of the first and second body segments of the cutting head assembly of FIG. 17.

### DESCRIPTION OF EMBODIMENTS

Below, particular embodiments according to the disclosure are described with reference to certain drawings but the disclosure is not limited thereto. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

Furthermore, the various embodiments, although referred to as “preferred” are to be construed as exemplary manners in which the disclosure may be implemented rather than as limiting the scope of the disclosure.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present disclosure, the only enumerated components of the device are A and B, and further the claim should be interpreted as including equivalents of those components.

### General Overview

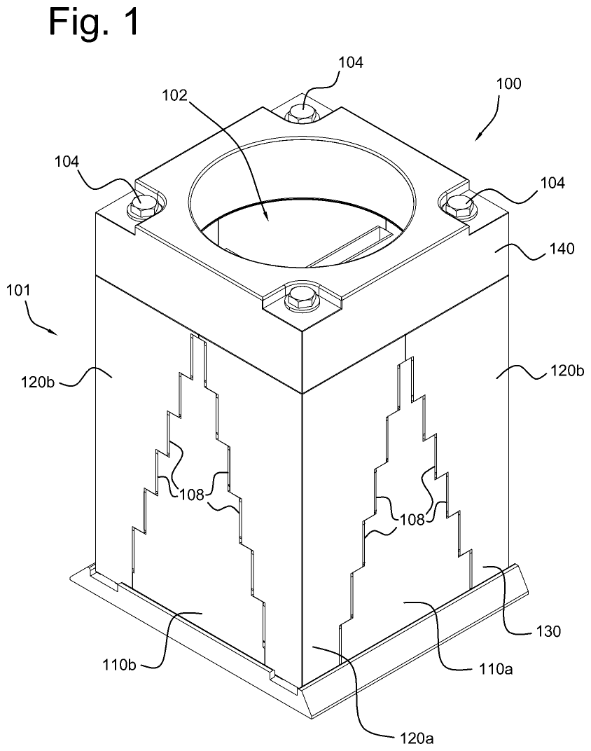

A first embodiment according to the present disclosure will be described with reference to FIGS. 1-16.

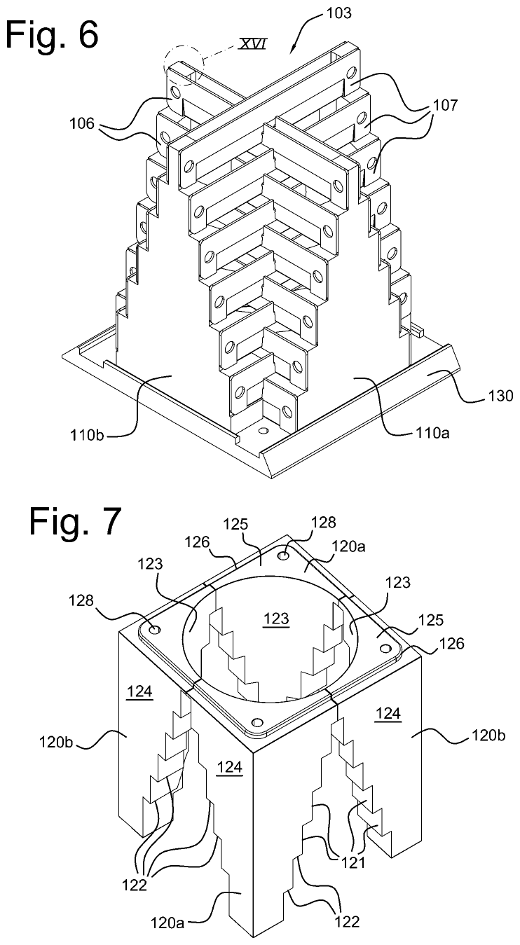

FIGS. 1, 2 and 3 show the cutting head assembly 100 in assembled state. The cutting head assembly 100 is provided for cutting food products into strips, to which end the cutting head assembly comprises a plurality of knives 106, 107, or cutter blades, stacked on top of each other and forming a knife stack 103 (see FIG. 6). The knives 106, 107 cross each other at right angles in a particular arrangement, above each other, in a pyramidal stack, so that the food products, mostly potatoes, are cut into bars, mostly French fries, mostly by means of an aqueous jet, at high velocity, through these crosswise arranged knives. The knives shown in the first embodiment are the same as described in U.S. Pat. No. 6,321,628 B1, which is incorporated herein by reference in its entirety. So the first embodiment of the cutting head assembly 100 is backwards compatible with these, and other existing knives.

FIG. 17 shows a second embodiment of a cutting head assembly 200 according to the present disclosure. Like reference numbers are used to indicate the same or similar parts as in the first embodiment. The second embodiment differs from the first in that positioning aids 201, 201′, 201″ are provided to aid in correctly positioning the knives 206, 207 upon assembling the knife stack 203. The knives 206, 207 used in this cutting head assembly 200 are provided with complementary notches 202, 202′, 202″ which cooperate with the positioning aids. A further difference in this cutting head assembly 200 is that the knives 206, 207 of the knife stack 203 are provided with features for reducing compression of the cut product as it passes through the knife stack. These features will be described in further detail below.

In embodiments according to the present disclosure, the cutting head assembly 100, 200 may be provided for being mounted in a hydraulic cutting system, for example for cutting potatoes or other vegetables into strips. In a typical hydraulic cutting apparatus wherein potatoes are to be cut, the potatoes are pumped through a conduit into an alignment chute wherein the potatoes are aligned and accelerated to high speeds before impinging upon the cutting head assembly where the potato is cut into a plurality of smaller pieces. The cutting head assemblies described herein are backwards compatible with existing hydraulic cutting systems, so that these are not further described herein. The cutting head assemblies described herein may further be used in other cutting systems wherein food or other products are to be cut into smaller pieces by feeding the product through a knife stack.

In the embodiments shown in the drawings, the cutting heads 100, 200 are fitted with straight knives which cross each other at right angles, such that they are provided for cutting strips with a rectangular or square cross-section, like for example French fries. The cutting heads may however also be used with knife stacks comprising wave-shaped knives or corrugated knives, such as for example known from US 2010/236,372 A1 and U.S. Pat. No. 7,096,771 B2, or other knife stacks. In alternative embodiments within the scope of the present disclosure, cutting head assemblies are envisaged wherein the knife sets do not cross each other at right angles, for example cutting head assemblies comprising body segments for holding knife sets at angles of e.g. 60°, for cutting strips with a triangular or hexagonal cross-section, or other angles for cutting strips with e.g. a diamond-shaped cross-section.

In embodiments according to the present disclosure, parts of the cutting head assembly 100, 200, for example the larger parts such as the first body segments, the second body segments, the bottom plate and/or the head block, may be made of a plastic material or composite, in order to reduce weight and/or material cost of the cutting heads. In other embodiments, these parts may be made of metal, e.g. a steel alloy, for example if a precise positioning of the parts with respect to each other is desired.

### Body

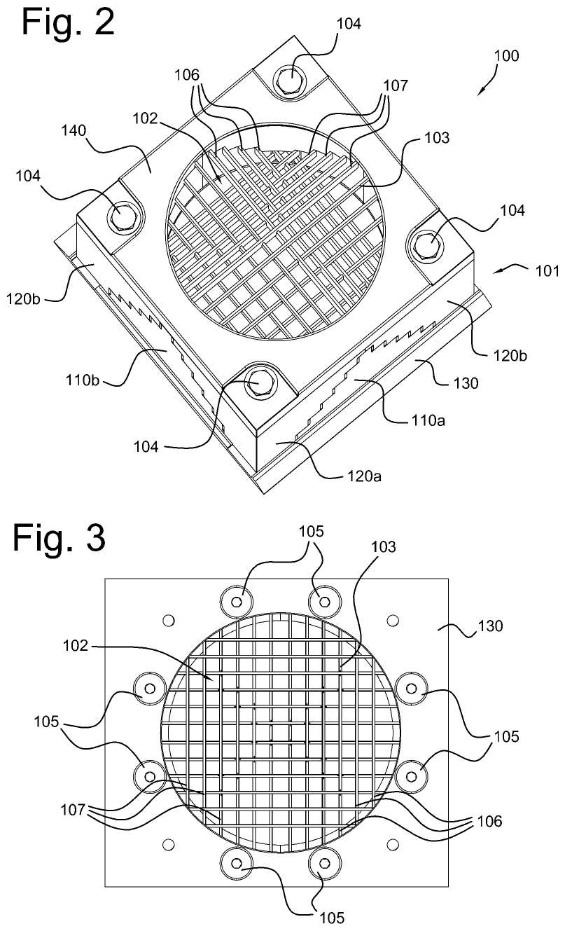

The cutting head assembly 100, 200 comprises a body 101 which holds the knife stack 103 and defines a central opening 102 which is crossed by the knives 106, 107 and through which the food products to be cut are driven from an entry side (bottom of FIG. 1) towards an exit side (top of FIG. 1). The central opening is preferably a cylindrical bore 102, although other shapes are possible as well. FIG. 2 shows a view onto the exit side and FIG. 3 shows a view onto the entry side of the cutting head. The body 101 is composed of first body segments 110 and second body segments 120 which mate with each other and form slots 108 which hold end portions of the knives 106, 107. Furthermore, the mating body segments 110, 120 also define the central opening 102 of the cutting head assembly by means of their respective inside surfaces 113, 123. In the assembled state, the knives 106, 107 are held between the opposing surfaces of the body segments 110, 120 and there is no longer a need for individually securing the knives to a holder by means of screws or the like. Furthermore, the body segments 110, 120 also mate into each other to form the central opening of the cutting head assembly, which is preferably cylindrical, so there is no need for additional parts to form or define the central opening 102. As a result, the cutting head assembly 100 has a reduced number of parts and/or may be assembled and disassembled more quickly.

In the embodiment shown, the body 101 comprises four first body segments 110 and four second body segments 120. In particular, there are two pairs of first body segments 110a and 110b and two pairs of second body segments 120a and 120b, the body segments of each pair being mounted opposite each other. The difference between the pairs of first body segments 110a and 110b on the one hand and the pairs of second body segments 120a and 120b on the other hand is due to the staggering of the knives. The knives 106 which extend in one direction are located on levels in between the levels of the other knives 107 which extend in the other direction.

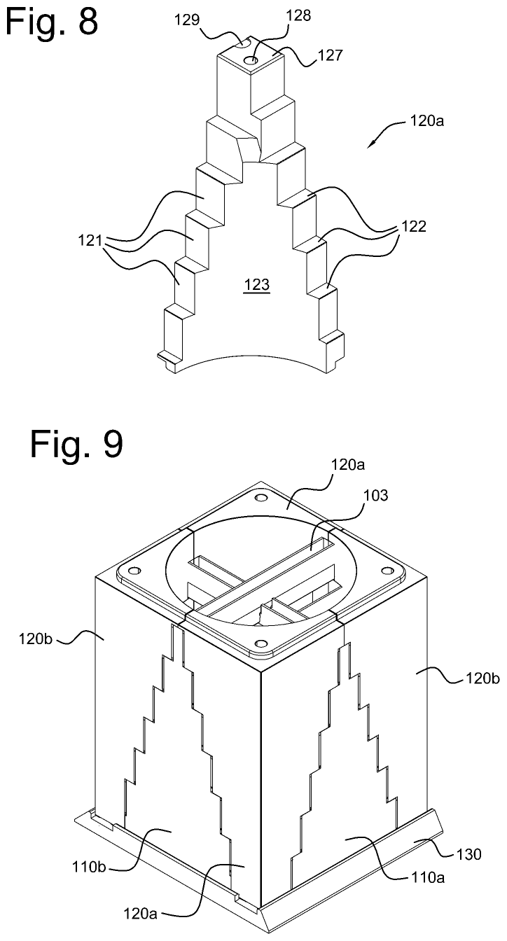

Each first body segment 110a, 110b, see also FIG. 5, has a stepwise tapered shape which tapers upwards, towards the exit side of the cutting head, and comprises a plurality of knife supporting surfaces 112 on which the knife ends are supported and first knife mounting surfaces 111, which extend in height direction and against which the knife ends are placed. Each second body segment 120a, 120b, see also FIGS. 7 and 8, has a stepwise tapered shape which tapers downwards, towards the entry side of the cutting head, and comprises a plurality of second knife mounting surfaces 121, arranged to oppose the first knife mounting surfaces 111, and knife clamping surfaces 122, arranged to push the knives down onto the knife supporting surfaces 112. In assembled state, the end portions of the knives 106, 107 are held in the slots 108 formed between the opposing first and second knife mounting surfaces 111, 121 of the first and second body segments 110a-b, 120a-b. The mating tapered shapes of the first and second body segments provide for a body 101 which holds the knives without individual bolts, thus resulting in a lot less parts compared to prior art knife holders and a more efficient assembling of the knife stack and the cutting head assembly as a whole.

The first body segments 110a-b together form a first, lower part of the body of the cutting head assembly (see FIG. 5). The second body segments 120a-b together form a second, upper part of the body of the cutting head assembly (see FIG. 7), which mates with the first part. By this construction, wherein the body is composed of a plurality of individual parts with a plurality of first body segments and second body segments, it has been found that, surprisingly, the surfaces 111, 112, 121, 122 for supporting and/or positioning the knives between the first and second parts can be defined more accurately, which may in turn lead to improvements in the positioning of the knives in the knife stack. In other words, it has been found that in this construction the manufacturing tolerances for these surfaces 111, 112, 121, 122 may be reduced, which may lead to an improved fit of the assembled first and second body segments on each other and, as a consequence, an improved accuracy of the knife positioning in the knife stack that is held between the first and second body segments.

In the examples shown in the drawings with a pyramidal knife stack comprising knives that cross each other at right angles, the body of the cutting head assembly has two pairs of first body segments 110a, 110b and two pairs of second body segments 120a, 120b. The body segments of each pair are identical in shape and size. In embodiments according to the present disclosure, the first, lower part of the housing may be composed of two, three, four, five, six, seven, eight or more first body segments and the second part of the housing may be composed of two, three, four, five, six, seven, eight or more second body segments. The preferred number of first and second body segments may depend on factors such as the material in which the segments are made, the manufacturing process, the configuration of the knife stack, or other.

### Clamping of the Body Segments

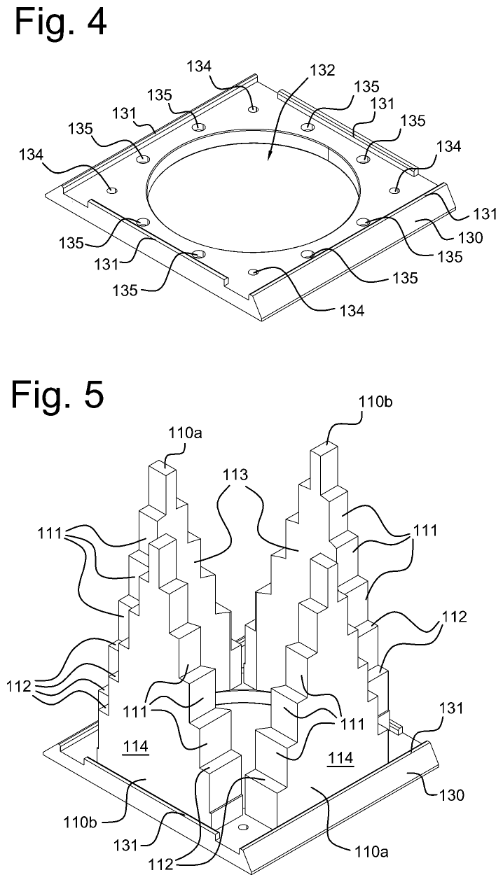

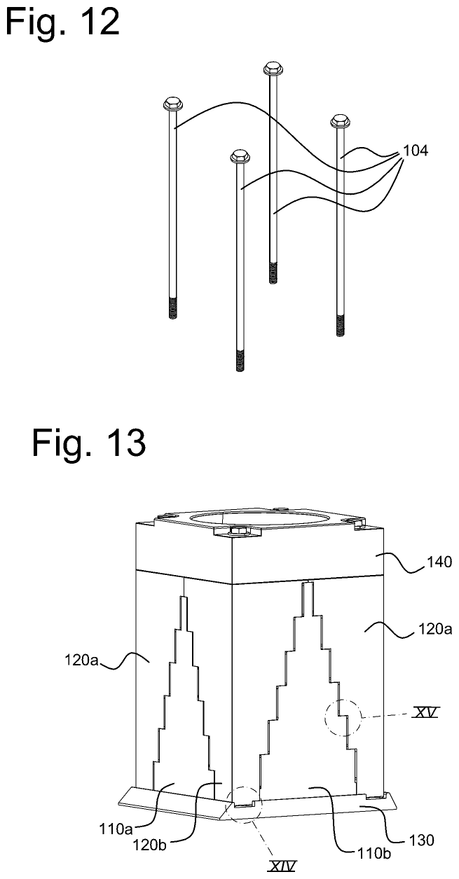

The cutting head assembly 100, 200 further comprises a clamping system, or clamping mechanism, for clamping the first and second body segments 110a-b, 120a-b onto each other. The clamping system comprises: a bottom part, provided for contacting bottom sides of the first body segments, a top part, provided for contacting top sides of the second body segments, and a mechanism for drawing the top and bottom parts towards each other and thereby clamping the first and second body segments in between them. In the embodiments shown, the bottom part is a bottom plate 130 (see FIG. 4) and the top part is a head block 140 (see FIGS. 7 and 8), which both have openings 132, 142 which align with the central opening 102 of the body 101. A number of clamping bolts 104 are applied for drawing the head block 140 towards the bottom plate 130, thereby pushing the second body segments 120 onto the first body segments 110, see FIGS. 12 and 13. The clamping bolts 104 are applied through aligned bores 144, 128, 134 which are provided in respectively the head block 140, the second body segments 120 and the bottom plate 130. In this way, the relative positions of the body segments into and onto each other and also the knives held in between them, are fixed. In this way, a quick and/or easy to use clamping mechanism is provided, for securing the first and second body segments 110a-b, 120a-b onto each other with the knives 106, 107 of the knife stack 103 held in between them, in accurate positions.

In alternative embodiments, clamping bolts and bores could be envisaged which extend through the first body segments 110 instead of the second body segments 120, or through both the first and second body segments. In further alternative embodiments, any other clamping mechanism for clamping the second body segments onto the first body segments with the knife stack held in between them, could be envisaged as well.

In the embodiments shown, the top and bottom parts 130, 140 of the clamping system comprise respective positioning ridges 131, 141 which in assembled state surround or mate with portions of the first and second body segments to ensure a correct positioning of the body segments with respect to each other.

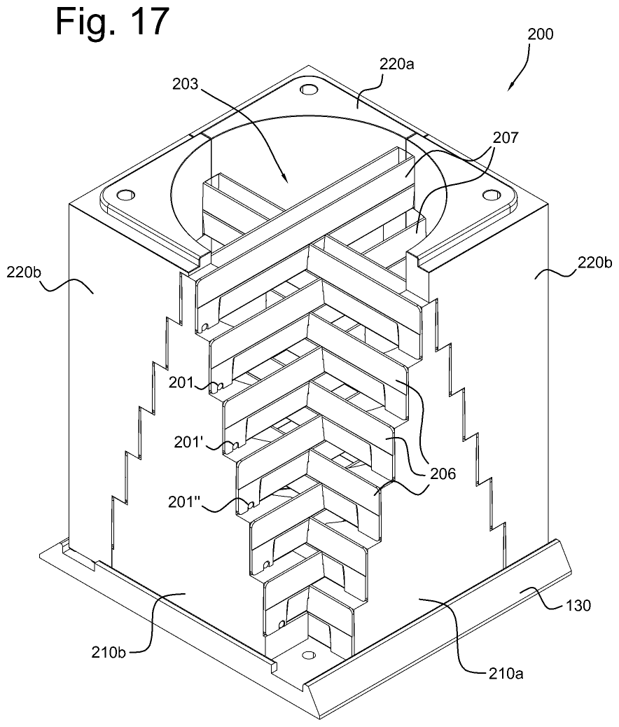

As shown, the bottom part may be a bottom plate 130 to which the first body segments 110a-b are bolted upon assembling the cutting head. The bolts 105, shown in FIG. 3, are provided through bores 135 in the bottom plate 130, shown in FIG. 4. The assembly of the bottom plate with the first body segments provides a simple construction, shown in FIG. 5, which can be placed in upright position for easily mounting and stacking the knives onto the first body segments, as shown in FIG. 6. In the assembled state, the positioning ridges 131 extend along the lower edges of the outside surfaces 114 of the first body segments and substantially define their final position in the completely assembled cutting head 100, 200. These positioning ridges 131 further provide for positioning the second body segments when they are placed on top of the first body segments, as shown in FIG. 9. In particular, in completely assembled state, the positioning ridges 131 almost completely surround the lower edges of the assembled body 101, except for a number of ridge openings 131 which are provided for purposes of disassembling the cutting head. These ridge openings 131 expose a bottom portion of the second body segments, as shown in detail in FIG. 16. In the bottom surface 127 of each of the second body segments, a notch 129 may be formed, see also FIG. 8, to allow insertion of a tool via the ridge openings and to pry the second body segments from between the positioning ridges 131 of the bottom plate 130.

It is evident that, in alternative embodiments, other cooperating positioning elements may be provided on the bottom plate 130 on the one hand and the first and/or second body segments 110a-b, 120a-b on the other hand in order to ensure a correct positioning of these parts with respect to each other.

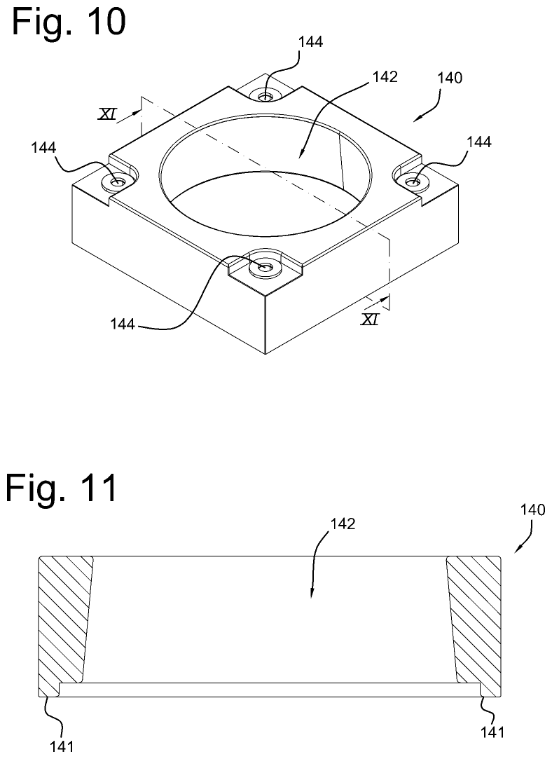

As shown, see FIGS. 10 and 11, the top part may be a head block 140 with a tapered (truncated cone-shaped) central opening which in assembled state aligns with the central opening 102 formed by the body segments and which tapers towards the exit side of the cutting head assembly. This tapered hole may provide for a more laminar flow of the liquid of a hydraulic cutting system through the cutting head.

In the assembled state, the positioning ridge 141, which extends downwards on the bottom side of the head block 140, surrounds complementary positioning ridges 126 on the top side of the second body segments and substantially defines their final position in the completely assembled cutting head 100, 200. These ridges 141, 126 together form cooperating positioning elements for on the one hand correctly positioning the head block on the second body segments and on the other hand securing the position of the second body segments with respect to each other. Preferably, the ridge 141 on the head block tightly fits around the ridges 126 on the second body segments, preferably such that the second body segments are pulled against each other when the head block 140 is placed on top of them. It is evident that, in alternative embodiments, other cooperating positioning elements may be provided on the head block and the second body segments in order to ensure a correct positioning of these parts with respect to each other.

### Clamping of the Knives

In the embodiments shown, each second body segment 120a-b comprises a plurality of clamping surfaces 122 which are arranged for pushing onto top sides of the end portions of the knives 106, 107. In this way, it can be ensured that in assembled state all the knives are pushed down onto each other and are accurately located in the desired position in the knife stack.

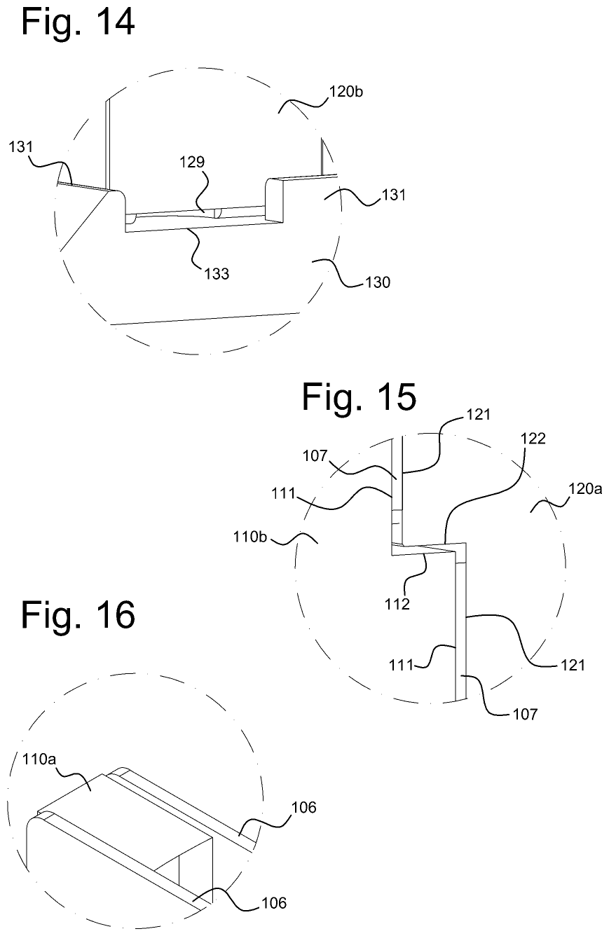

In particular, in assembled state, bottom surfaces 127 of the second body segments are spaced from the bottom plate 130, as shown in the detail of FIG. 14. Further, the height of the knives 106, 107 is such that they extend slightly above the first mounting surfaces 111 of the first body segments, as shown in the detail of FIG. 16. In this way, it can be ensured that upon assembling the cutting head the clamping surfaces 122 of the second body segments push the knives down onto the knife supporting surfaces 112 and that the bottom surfaces 127 of the second body segments do not touch the bottom plate 130, thus form no obstruction for pushing the knives down. In this way, it can be ensured that the knives 106, 107 of the complete knife stack 103 are correctly held in the slots 108 formed between the (vertical) first and second mounting surfaces 111, 121 and the (horizontal) knife supporting surfaces 112 and clamping surfaces 122, as shown in the detail of FIG. 15.

### Positioning Aids

The cutting head assembly 200 shown in FIG. 17 differs from the cutting head assembly 100 by the provision of positioning aids for placing the knives sequentially onto the first body segments. In particular, the first body segments 210a-b are provided with positioning aids on each knife level which define which respective knife is to be mounted on that level. In the embodiment shown, protrusions 201, 201′, 201″ are provided on the first mounting surfaces on at least one side of the upwards tapering first body segments, wherein the protrusions are positioned differently on each level. For example, the protrusions may be positioned a given distance, e.g. 1 mm difference, with respect to the preceding/subsequent level, measured from the outside surface 114 towards the central opening 102. In the embodiment shown in FIG. 17, this distance increases from top to bottom of the cutting head, but obviously this distance may also decrease. More generally, the positioning aids may also be carried out in different ways, wherein the positioning aids on each level preferably define one respective set of knives to be mounted on that level.

The protrusions 201, 201′, 201″ can be easily made on the first body segments, for example by drilling holes of a predefined depth into the knife mounting surfaces 204 at the appropriate locations and then inserting a dowel pen into each hole. The predefined depth of the holes is less than the length of the dowel pens, such that these protrude from the knife mounting surfaces, but enough to obtain that the dowel pens do not obstruct the mounting of the second body segments.

The knives 206, 207 are provided with complementary shapes or features which cooperate with the positioning aids. FIGS. 23-25 show a few possible embodiments of the positioning aids and complementary features on the knives.

In the embodiment shown in FIG. 23, which is used in the cutting head 200 shown in FIG. 17, the knives 206, 206′, 206″ are provided with notches 202, 202′, 202″ of which the position on the respective knife corresponds to the position of the protrusion 201, 201′, 201″ on the respective level of the first body segments. In this embodiment, the placement of an incorrect knife will be prevented because the protrusion 201, 201′, 201″ forms an obstruction when its position does not correspond to the position of the notch 202, 202′, 202″.

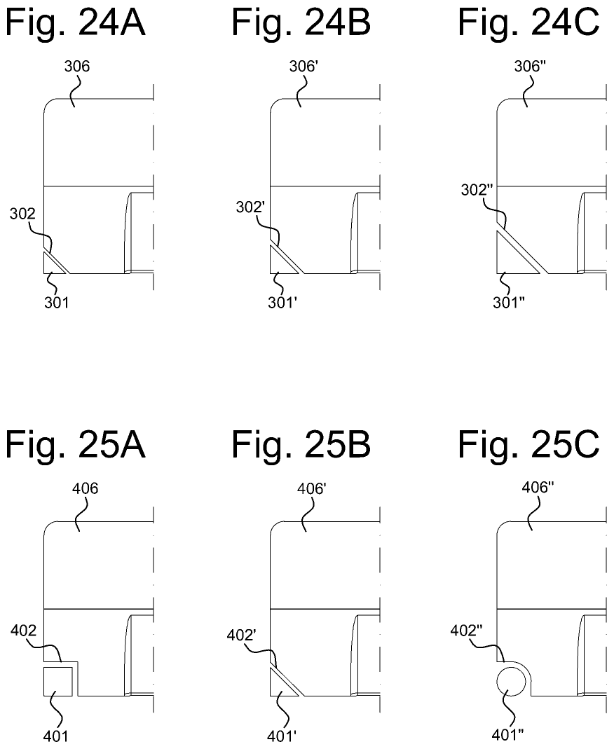

In the embodiment of FIG. 24, the knives 306, 306′, 306″ have a cut-out corner 302, 302′, 302″ which corresponds to a triangular protrusion 301, 301′, 301″ on the first body segments. As shown, the size of the cut-out corner and the corresponding triangular protrusion varies per level. In this embodiment, placement of an incorrect knife at a certain level may not always be obstructed by the respective protrusion 301, 301′, 301″, but at least the difference in size between the protrusion and the cut-out corner may give an indication to the user that there is something wrong.

As shown, the size of the cut-out corner and the corresponding triangular protrusion varies per level. In the embodiment of FIG. 25, the knives 406, 406′, 406″ have cut-out corners 402, 402′, 402″ of different shapes which correspond to respective protrusions 401, 401′, 401″ of substantially the same shapes on the first body segments. As shown, the shape of the cut-out corner and the corresponding protrusion varies per level. In this embodiment, placement of an incorrect knife at a certain level may not always be obstructed by the respective protrusion 401, 401′, 401″, but at least the difference in shape between the protrusion and the cut-out corner may give an indication to the user that there is something wrong.

It is evident that the positioning aids on the first body segments and the complementary shapes or features on the knives can be carried out in various other ways within the scope of the present disclosure. For example, instead of the notches or cut-outs shown in FIGS. 23-25, the knives may have holes of varying sizes and/or positions in the end portions (by which the knives are held in the slots between the body segments) and the first body segments may be provided with protrusions of varying sizes and/or positions complementary to such holes.

The protrusions 201, 301, 401 can be manufactured on the first body segments in multiple ways. In embodiments, the protrusions may be formed as integral parts of the first body segments. In other embodiments, holes may be made in the knife mounting surfaces 204 at the appropriate location, wherein an additional element providing the desired protrusion at the desired position and/or with the desired shape and/or size is then inserted and/or fixed in said hole, such as for example the dowel pens in the embodiment of FIG. 17.

In alternative embodiments, or in combination, protrusions may also be provided on the knife mounting surfaces 204 of the second body segments. The protrusions may be carried out in the same or similar ways as has been described above for the first body segments.

In a further embodiment, shown in FIGS. 28-29, the positioning aids (protrusions) on the body segments and complementary shapes/features on the knives may be purposely offset with respect to each other in such a way that, when the knives are pushed down over the positioning aids upon assembling the cutting head assembly, the knives are longitudinally stretched or tensioned. Preferred shapes for such a tensioning feature are the triangular protrusions 501 and V-shaped notches 502 shown in FIGS. 28-29. As shown, the triangular protrusions 501, which are provided on the (first) body segments, are spaced apart slightly more than the corresponding V-shaped notches 502 provided in the bottom sides of the knives. As a result, when the knife 506 is pushed down over the triangular protrusions 501, the knife is slightly longitudinally stretched, which tensions the knife and thus the cutting edge in its longitudinal direction. This may in turn lead to improvements during operation, because the longitudinal tension on the knife may reduce bending of the knife and may lead to improved cuts and/or longer knife lifetime. A preferred range for the offset is 0.1 mm to 2 mm on one or both ends of the knife. The offset may depend on the angle of the sides notches 502 shown in the figure. In embodiments, the angle of the sides of the notches may be different from the angle shown in the figure (which is about 60°). For a steeper angle, a smaller offset may be preferred. For example if the side of the notch is almost perpendicular to the edge, an offset closer to the lower limit of 0.10 mm may be preferred. For larger angles, for example 45° or more, a larger offset may be used to achieve that the knife is placed under more tension when it is pressed down.

In embodiments, such a knife tensioning feature with knife tensioning means (e.g. protrusions 501) and corresponding tensioning elements (e.g. notches 502) for longitudinally tensioning the knives may also be applied as such, i.e. separately from the positioning aids. In other words, the same knife tensioning feature may be applied on each level in the knife stack, i.e. with the protrusions and notches in the same position on each level. In other embodiments, the knife tensioning feature may be combined with the positioning aids, which means that the position of the protrusions 501 and notches 502 is shifted on each knife level in the same way as has been described above for the positioning aids with reference to FIGS. 17 and 23-25.

### Assembly Method

The method for assembling the cutting head assembly 100, 200 is shown sequentially by means of FIGS. 4 to 13. Generally, the method comprises the steps of providing the first body segments, placing the knife stack on the first body segments, applying the second body segments and clamping the first and body segments onto each other with the knife stack held in between them. More in detail, the method comprises the following steps.

As shown in FIGS. 4 and 5, the first body segments 110a-b of the body are placed on and bolted to the bottom plate 130, to form the pyramidal structure for easily stacking the knives 106, 107.

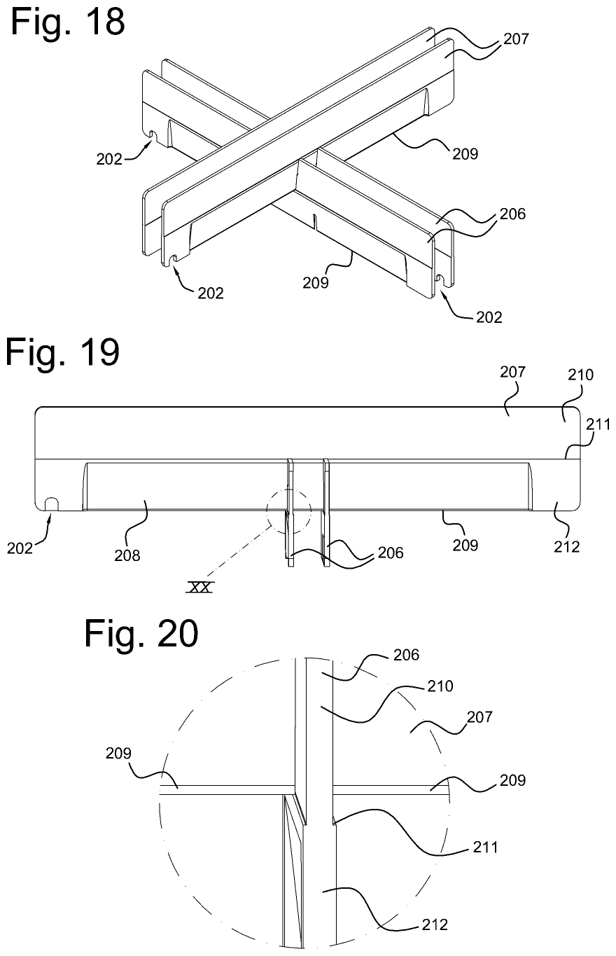

Next, as shown in FIG. 6, the knives are placed on the structure for forming the knife stack 103. In the embodiment shown in FIG. 6, the knife stack is the same as described in U.S. Pat. No. 6,321,628 B1 (as mentioned above). Therefore, the stacking of these knives is not described in detail herein for the sake of brevity. In summary, a first set of knives 106 is placed on the lowest level, on the bottom plate 130 and against the respective first mounting surfaces 111. Next, a second set of knives 107 is stacked on top of the first set by aligning the notches in the knives 106, 107 and placing the second set of knives on the knife supporting surfaces 112 and against the mounting surfaces 111 of the level above the lowest level, and so on. With the embodiment shown in FIGS. 17 and 18, the positioning aids 201 and corresponding notches 202 in the knives help to make sure that each time the correct knife set is taken by the user and placed correctly on the knife stack.

Next, as shown in FIGS. 7-9, the second body segments 120a-b are placed on top of the first body segments 110a-b, whereby the end portions of the knives are held in the slots 108 formed between the first and second body segments and whereby the central opening 102 is formed. The ridges 131 on the bottom plate 130 help to correctly position the second body segments 120a-b.

Next, as shown in FIGS. 10-13, the head block 140 is placed on top of the second body segments 120a-b with the ridge 141 fitting over and around the ridges 126 on the top side of the second body segments. The bolts 104 are inserted from the top through the bores 144, 128 in the head block 140 and the second body segments 120a-b, and screwed into the bores 134 in the bottom plate 130, thereby drawing the head block 140 towards the bottom plate 130 and clamping the body segments in between. In this process, the second body segments push the knives 106, 107 down, by means of the knife clamping surfaces 122 onto the knife supporting surfaces 112 of the first body segments.

In the embodiment shown in FIGS. 4-13, the cutting head is assembled starting with the “first” body segments (as they are called herein) and with the knives of the knife stack facing downwards, i.e. with their cutting edges directed downwards. In embodiments within the scope of the present disclosure, the assembly method may also start with the “second” body segments (as they are called herein), turned upside down, preferably placed on or fixed to the head block which is also turned upside down, and placing the knives on these body segments with their cutting edges facing upwards. It is evident that both ways are possible and are envisaged according to the present disclosure: the head block may function as base for mounting the second body segments first in substantially the same way as the bottom plate for the first body segments; and the bottom plate may function as top part of the clamping mechanism in substantially the same way as the head block. However, the method with the knives facing downwards as described in detail above may be preferred for safety reasons.

### Knife Stack

As mentioned above, the cutting head assembly 100 of FIGS. 1-16 is suitable for use with prior art knives as well as new knives, such as for example the knives shown in FIGS. 17-25. In particular, even though the cutting head assembly 100 does not comprise the positioning aids 201, it is still suitable for use with the knives shown in FIGS. 17-25. The notches 202 or cut-outs 302, 402 in the knives then simply have no function. The cutting head assembly 200 of FIG. 17 is particularly suited for the knives 206, 207 which have positioning features (notches 202) that are complementary to the positioning aids (protrusions 201).

The present disclosure further relates to knives 206-207, 306, 406 as such, for forming a knife stack 203 for use with, for example but not exclusively, a cutting head assembly according to the present disclosure. Each knife 206-207, 306, 406 comprises a longitudinal cutting edge 209, a lower portion 212 which extends upwards from the cutting edge and an upper portion 210 which extends upwards from the lower portion.

In embodiments, as shown in FIGS. 18-20, the upper portion 210 may have a reduced thickness with respect to the lower portion 212. This implies that the knives comprise a step 211 at the transition from the lower portion to the upper portion, which extends in longitudinal direction of the knife and preferably over the entire length of the knife. In the figure, the step 211 is shown as a sudden transition, but a more smooth or gradual transition from the lower (thicker) portion 212 to the upper (thinner) portion 210 is possible as well.

More in particular, the lower portion 212 has a bevelled portion 208 at the cutting edge 209, where the thickness gradually increases starting from the cutting edge up to a middle portion of the knife, which is the thickest portion of the knife and located just below the step 211, and the upper portion 210 preferably has a reduced thickness with respect to this thickest middle portion of the knife. Except for the bevelled portion 208, the lower portion 212 may generally have substantially the same thickness, i.e. at the middle portion and at end portions of the knife on opposite sides of the bevelled portion 208. The reduced thickness of the upper portion 210 with respect to the lower portion may achieve that cut off portions of product which is fed through the knife stack are less compressed between the knives. In particular, in the embodiment shown, the cut product may be compressed between knives of the same level and possibly also between a knife and the inside surface of the body, by the increasing thickness of the knives upwards from the cutting edge 209. The continuous, middle portion of maximum thickness at the step 211 is preferred in view of a desired strength of the knives, but upwards from the step 211 the thickness of the knives is reduced again. This not only avoids compression of the cut product, but also reduces the risk that product would become jammed in the cutting head.

In embodiments, as shown in FIGS. 18-22, the upper portion 210 and/or the lower portion 212 of each knife (except for the lowest and top level knives) may comprise slots 213, 216 for receiving the knives of the preceding and/or subsequent level of the knife stack. In this way, the total height of the cutting head assembly 100, 200 can be reduced. Preferably, the slots 216 in the lower portion 212 have a predetermined width which is (slightly) wider than the thickness of the upper portion 210 and narrower than the thickness of the lower portion 212. As shown in FIG. 20, this has the effect that the cutting edge 209 extends behind the step 211 on both sides of the slot 216, such that there is at each level a portion of the cutting edge of the respective knife behind the step of the knife on the preceding level. In this way, it can be ensured that the product is completely cut at each level, consequently avoiding that fibers of the cut product get stuck or build up in the slots in the lower portions of the knives.

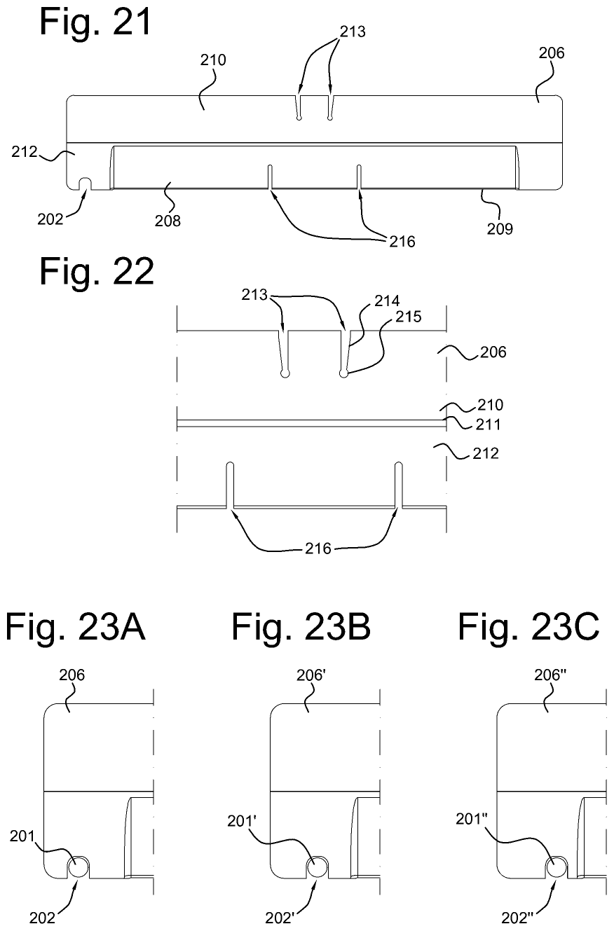

In embodiments, the slots in the upper portions of the knives may be tapered, such that these slots substantially conform to the cross-section of the lower portion of the knives (which tapers due to the bevelled portion). Preferably, the bottom end of the slots in the upper portions are contoured or rounded to avoid cracking of the knives. FIGS. 21-22 show an embodiment of such tapered slots with a tapering portion 214 and a contoured bottom end 215.

The thickness (full thickness of the lower portion 212) of the knives may for example be 0.5 to 2.0 mm, preferably 0.8 to 1.5 mm, more preferably 1.0 to 1.3 mm, for example about 1.0 mm or 1.25 mm. The reduced thickness of the upper portion 210 may for example be 70% to 90% of the full thickness, preferably about 80%, for example about 0.8 mm or 1.0 mm. The length of the knives may for example be 8 to 20 cm, preferably 10 to 15 cm, more preferably about 12 cm. The height of the knives may for example be 10 to 35 mm, preferably 15 to 30 mm, for example about 19 mm or 25 mm. The height of the upper and lower portions 210, 212 is preferably about the same. The step 211 is preferably present on both sides of the knife and is preferably the same on both sides of the knife.

The slots 213, 216 in the upper and/or lower portions of the knives may for example be 2 to 10% wider than the thickness of the respective portion of the knives for which the slot is intended. For example, for knives with upper portions of 1.0 mm, the slots 216 in the lower portions of the knives may for example have a width of 1.02 to 1.10 mm. Preferably, the slots 213, 216 are 4 to 8% wider, more preferably about 6% wider than the thickness of the respective portion of the knife for which the slot is intended.

The knives are preferably made of metal, preferably a steel alloy. The knives are preferably bevelled on one side only, i.e. the back side of the lower portion 212 is preferably flat. A pair of knives on the same level is preferably oriented with the flat back sides directed towards each other, i.e. with the bevelled portions 208 directed away from each other, as shown in FIG. 18, to reduce the risk of product getting jammed in between the knives. The cutting edges 209 are preferably bevelled on the same side as the bevelled portions 208, at a different angle with respect to the height direction of the knives. The cutting edges 209 may however also have a dual bevel, i.e. be bevelled on both sides of the knives. In embodiments, an edge portion of the knives along the cutting edge 209 may be made of a different, preferably harder material, than the rest of the knife. In this way, more durable knives may be obtained and/or knives which may be resharpened more times.

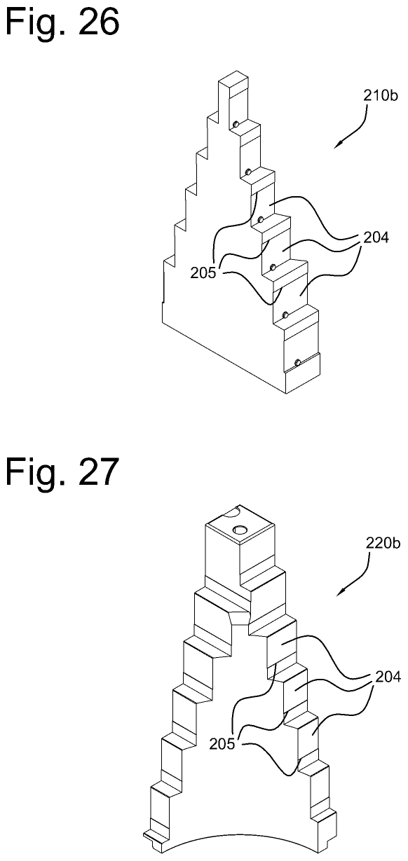

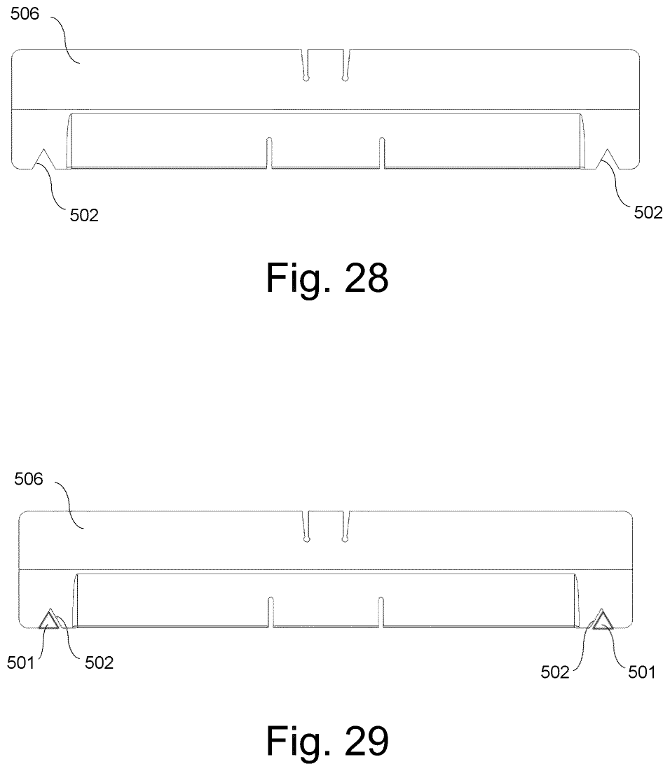

The cutting head 200 shown in FIG. 17 may have complementary steps 205 or transitional portions on the knife mounting surfaces 204 of the first and second body portions 210, 220, such that the knife mounting surfaces more closely fit with the knife surfaces and that gaps, as a result of the reduced thickness portions of the knives, are minimized. FIGS. 26 and 27 show perspective views of the first and second body segments of the cutting head assembly of FIG. 17.

### Advantages

Embodiments of the cutting heads 100, 200 and/or knife assemblies 203 as described herein may involve one or more of the following advantages over prior art assemblies.

Reduced friction or cutting force: as a potato is introduced into the water stream by means of a low shear pump it is accelerated in the last meters up to speeds of e.g. 27 m/s. Once it strikes the first knives in the grid it begins to slow down. Friction and cutting force may decelerate the potato significantly. This deceleration must not be greater than the speed of the following potato or the beginning of a jam may occur. Increasing the speed is not desired due to higher cutting velocities, which may result in potato damage and starch losses. With the cutting head assemblies and knife stacks as described herein, the velocity may be reduced compared to prior art systems. Running the velocity as slow as possible is desirable both for the potato integrity and for energy consumption.

Reduced compression: as a potato passes through the knives the uncut portion is in between two opposing knives and the cut portion peals off the bevel side of the knife as a slab and eventually as a fry. The uncut portion may be squeezed between the knives causing the knives to bow while the potato is compressed. As knives dull it is believed compression increases. Compression is an unwanted side effect that creates cell damage, increased friction and requires greater and greater water pressure to overcome. Reducing compression is therefore desirable. With the cutting head assemblies and knife stacks as described herein, compression may be reduced compared to prior art systems, a.o. as a result of the reduced thickness of the upper portions of the knives.

More laminar flow: laminar flow of both the potato and fry are desirable. Eddy currents outside the flow may reduce the efficiency of the water pump causing the pump to need to be over speed to achieve terminal velocity on the input side. On the output side fries that tumble in eddy currents may risk to break and discharge starch. Improving laminar flow is therefore desirable. With the cutting head assemblies and knife stacks as described herein, a more laminar flow may be achieved compared to prior art systems, a.o. as a result of the cylindrical central opening and the tapered bore of the head block.

Improved cut accuracy: demanding food service customers may hold producers to a very high standard regarding the quality of the cut product. Accuracy is important so that, for example, a specific number of fries are present in every fry box the consumer buys, and that quality is continuous. With the cutting head assemblies and knife stack as described herein, repetitive results over longer runs (i.e. with increased production in between interruptions for e.g. replacing the knives) may be achieved.

Longer edge life: the knives may be replaced in between production sessions for three reasons: specification change, knife dullness or knife damage. Knife life may vary for many reasons, but a longer knife life is desirable. With the cutting head assemblies and knife stacks as described herein, knife life may be extended compared to prior art systems.

Knife fatigue: when metal is put under tension it reaches a point where it deflects. When a material deflects to a point where it does not return to its original shape it is known as yield strength. Yield is something entirely different than fatigue. When a material fails under fatigue it means the material deflected to a point less than yield thousands if not millions of times. Normally a material can fail due to fatigue in the weakest point of the structure. This could be a fisher, a sharp corner, a thin cross section, a scratch, a concentration of hydrogen embrittlement, too large of grain structure, a rough machining process, a design that does not allow for flexibility of the material, chemical erosion, physical erosion and even material quality/impurities. With the cutting head assemblies and knife stacks as described herein, the number of cycles before fatigue failure may be increased compared to prior art systems.

Less risk of product damage by sprout fibers: potatoes that are stored begin to change physiologically depending on the quality of storage. Some potatoes will grow sprouts. Sprouts are extremely fibrous and difficult to cut. Sprout fibers get stuck in the slots of the knives where they intersect. These fibers stay in the slots and build up. When looking at a fry it passes directly on the 4 corner edges. These fibers rub on the fry corner and tear off some material that becomes scrap and starch. Having sharp corners on French fries is therefore desirable. With the cutting head assemblies and knife stacks as described herein, the build-up of sprout fibres in the cutting head can be reduced compared to prior art systems.

Ergonomic design: in between production sessions, operators are replacing cutting heads as the knives become dull. It may take more than 30 minutes to replace knives in a traditional pyramid cutting head, which may account for many hours of downtime in a day. Reducing the knife changeover time and reducing the chance for incorrect knife placement is therefore desirable. With the cutting head assemblies and knife stacks as described herein, the downtime may be reduced compared to prior art systems, a.o. by the simple construction, the short assembly time, the positioning aids which can avoid incorrect knife placement, etc.

1. A cutting head assembly for cutting food products into strips, the cutting head assembly comprising:
a plurality of knives provided to be stacked on top of each other to form a knife stack for cutting food products, which are driven through a central opening of the cutting head assembly from an entry side towards an exit side, into strips, and
a body for holding the knife stack,
wherein the body comprises a number of first body segments and a number of second body segments wherein the first and second body segments mate with each other and are together provided for forming slots for holding end portions of the knives and for defining the central opening of the cutting head assembly.

2. The cutting head assembly according to claim 1,
wherein each first body segment has a stepwise tapered shape which tapers upwards, towards the exit side, and comprises a plurality of first knife mounting surfaces,
wherein each second body segment has a stepwise tapered shape which tapers downwards, towards the entry side, and comprises a plurality of second knife mounting surfaces, arranged to oppose the first knife mounting surfaces, and
wherein in assembled state the end portions of the knives are held in the slots formed between the opposing first and second knife mounting surfaces of the first and second body segments.

3. The cutting head assembly according to claim 1, wherein the cutting head assembly further comprises a clamping system for clamping the first and second body segments onto each other.

4. The cutting head assembly according to claim 3, wherein the clamping system comprises:
a bottom part, provided for contacting bottom sides of the first body segments,
a top part, provided for contacting top sides of the second body segments, and
a plurality of clamping bolts for drawing the top part towards the bottom part with the first and second body segments clamped in between the top part and the bottom part.

5. The cutting head assembly according to claim 4, wherein in assembled state, the clamping bolts extend through bores which are provided in height direction of the cutting head assembly through at least some of the body segments.

6. The cutting head assembly according to claim 5, wherein the bores are provided in the first body segments.

7. The cutting head assembly according to claim 3, wherein each second body segment comprises a plurality of clamping surfaces arranged for pushing onto top sides of the end portions of the knives.

8. The cutting head assembly according to claim 7, wherein in assembled state, bottom surfaces of the second body segments are spaced from the bottom part.

9. The cutting head assembly according to claim 4, wherein the top and bottom parts comprise positioning ridges which in assembled state surround or mate with portions of the first and second body segments to ensure a correct positioning of the body segments with respect to each other.

10. The cutting head assembly according to claim 4, wherein the bottom part is a bottom plate and wherein in assembled state, the first body segments are bolted to the bottom plate.

11. The cutting head assembly according to claim 4, wherein the top part is a head block with a tapered central opening which in assembled state aligns with the central opening formed by the body segments and which tapers towards the exit side of the cutting head assembly.

12. The cutting head assembly according to claim 1, wherein the first body segments are provided with positioning aids to aid in correctly positioning the knives upon assembling the knife stack.

13. The cutting head assembly according to claim 1, wherein the first body segments are provided with knife tensioning means for longitudinally tensioning the knives.

14. The cutting head assembly according to claim 1, wherein the cutting head assembly is provided for being mounted in a hydraulic cutting system.

15. A set of knives for forming a knife stack as part of a cutting head assembly according to claim 1.

16. The set of knives of claim 15, wherein each knife comprises a longitudinal cutting edge, a lower portion which extends upwards from the cutting edge and an upper portion which extends upwards from the lower portion, and wherein the upper portion has a reduced thickness with respect to the lower portion.

17. The set of knives of claim 15, wherein at least one of the upper portion and the lower portion of each knife comprises at least one slot for receiving a knife of the preceding or subsequent level of the knife stack.

18. The set of knives of claim 17, wherein slots in the upper portions of the knives are tapered and preferably have a contoured bottom end.

19. The set of knives of claim 15, wherein the knives are provided with positioning elements complementary to positioning aids provided on the first and/or second body segments of the cutting head assembly.

20. The set of knives of claim 19, wherein the positioning elements on the knives correspond in position, shape and/or size with the positioning aids on the first and/or second body segments of the cutting head assembly.

21. The set of knives of claim 15, wherein the knives are provided with tensioning elements corresponding to knife tensioning means provided on the first and/or second body segments of the cutting head assembly.

22. The set of knives of claim 21, wherein the tensioning elements are provided in the form of notches in the knives which correspond to protrusions on the first and/or second body segments, preferably V-shaped notches and triangular protrusions, wherein the notches and protrusions are purposely offset with respect to each other for longitudinally tensioning the knives.

23. A method for assembling a cutting head assembly according to claim 1, the method comprising the steps of:
mounting the first body segments,
mounting the knives on the first body segments to form the knife stack,
mounting the second body segments on the first body segments, whereby the end portions of the knives are held in the slots formed between the first and second body segments and whereby the central opening is formed.

24. The method according to claim 23, wherein the first body segments are bolted to a bottom part of the cutting head assembly and wherein the second body segments are clamped onto the first body segments by means of a clamping system.

25. The method according to claim 24, wherein the second body segments, upon being clamped onto the first body segments, push the knives down onto knife supporting surfaces on the first body segments.
